(19) United States
(12) Patent Application Publication
(10) Pub. No.: US 2007/0240485 A1
(43) Pub. Date: Oct. 18, 2007

(54) Gas sensor with increased sealing performance

(75) Inventor: Keiji Kanao, Aichi-ken (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/714,803

(22) Filed: Mar. 7, 2007

(30) Foreign Application Priority Data
Apr. 18, 2006 (JP) 2006-114340

(51) Int. Cl. G01N 27/00

(52) U.S. Cl. 73/1.06

(57) ABSTRACT

A gas sensor is disclosed having a gas sensing element, an insulating element holder and a housing. The insulating element holder has a stepped engaging shoulder and the housing has an outer periphery, formed with a tool-fitting portion adapted to engage a mounting tool, and an inner peripheral wall having a holder rest shoulder facing the stepped engaging shoulder. A packing element is interposed between the stepped engaging shoulder and the holder rest shoulder so as to provide a hermetically sealing effect between an atmospheric side ambience of the gas sensor and a measuring gas side ambience thereof. The holder rest shoulder is formed at an opening angle, representing an angle defined with a pair of profile lines on a plane including a center axis of the gas sensor in cross section thereof, which is set to be less than 100°.

### CROSS REFERENCE TO RELATED APPLICATIONS

This application is related to Japanese Patent Application No. No. 2006-114340, filed on Apr. 18, 2006, the content of which is hereby incorporated by reference.

### BACKGROUND OF THE INVENTION

1. Technical Field of the Invention

The present invention relates to gas sensors for use in motor vehicles and, more particularly, to a gas sensor that can be used as a sensor for detecting a concentration of specified gas in measuring gases for use in controlling a combustion state of an internal combustion engine such as a vehicle engine.

2. Description of the Related Art

In the related art, attempts have heretofore been made to provide a gas sensor mounted on an exhaust pipe of an automotive engine for detecting a concentration of specified gas such as oxygen in measuring gases as disclosed in Japanese Patent Unexamined Patent Application Publication No. 2002-82085.

As shown in FIG. 10, the gas sensor of such a related art comprises a sensing element 92 for detecting a concentration of specified gas in measuring gases, an insulating element holder 93 for holding the sensing element 92, and a housing 94 accommodating therein the insulating element holder 93 in fixed place.

The insulating element holder 93 has an outer circumferential periphery 932 formed with an stepped engaging shoulder 930. The housing 94 has an inner circumferential periphery 942 formed with an holder rest shoulder 940 in face-to-face relation with the stepped engaging shoulder 930 of the insulating element holder 93.

With such a structure of the gas sensor shown in FIG. 10, the stepped engaging shoulder 930 of the insulating element holder 93 and the holder rest shoulder 940 of the housing 94 are held in abutting engagement with each other by means of a packing element 95. Thus, the packing element 95 serves to hermetically seal off an atmospheric side atmosphere 912 and a measuring gas atmosphere 911 from each other.

The housing 94 has an outer circumferential periphery formed with a tool-fitting portion 941. The gas sensor 9 is tightened and fixed to the exhaust pipe turned with a leading end of the gas sensing element 92 inserted to an interior of the exhaust pipe. When installing the gas sensor 9 on the exhaust pipe of the automotive engine, turning the tool-fitting portion 941 of the housing 94 with a mounting tool allows a threaded portion 943 of the housing 94 to be tightly screwed into a threaded bore of the exhaust pipe (not shown).

However, when tightening the gas sensor 9 in fixed place using an impact wrench as the mounting tool, the packing element 95 and neighboring parts are applied with impact shock in excess. When this takes place, there is a fear of a drop in tight contact among the insulating element holder 93, the housing 94 and the packing element 95. This results in the occurrence of a fear of a drop in tight contact between the atmospheric side atmosphere 912 and the measuring gas atmosphere 911.

### SUMMARY OF THE INVENTION

The present invention has been completed with a view to addressing the above issues and has an object to provide a gas sensor that provides an increased hermetically sealing effect between an atmospheric side atmosphere and a measuring gas atmosphere.

To achieve the above object, a first aspect of the present invention provides a gas sensor comprising a sensing element for detecting a concentration of specified gas in measuring gases, an insulating element holder internally supporting the sensing element and having an stepped engaging shoulder, a housing having first and second inner peripheral walls between which an holder rest shoulder is formed in face-to-face relation with the stepped engaging shoulder of the insulating element holder for internally supporting the insulating element holder, and a packing element interposed between the stepped engaging shoulder of the insulating element holder and the holder rest shoulder of the housing. An atmospheric side cover is fixedly connected to one end of the housing so as to cover a base end portion of the sensing element in an atmospheric side atmosphere, and a measuring gas side cover fixedly connected to the other end of the housing so as to cover a leading end portion of the sensing element in a measuring gas atmosphere. The holder rest shoulder is formed in the housing at an opening angle less than 100°, representing an angle defined with a pair of profile lines in a cross section on a plane including a center axis of the gas sensor, which allows the packing element to hermetically seal the atmospheric side atmosphere and the measuring gas atmosphere from each other.

With such a structure of the gas sensor, the housing has the holder rest shoulder formed at an opening angle less than 100°. This enables the packing element to provide an increased hermetically sealing effect between the atmospheric side atmosphere and the measuring gas atmosphere.

That is, with the packing element held in pressured contact between the stepped engaging shoulder of the insulating element holder and the holder rest shoulder of the housing, an urging force is exerted to the packing element toward a leading end of the gas sensor in an axial direction thereof. When this takes place, the packing element held in tight contact between the stepped engaging shoulder of the insulating element holder and the holder rest shoulder of the housing. This provides an increased hermetically sealing effect between the atmospheric side atmosphere and the measuring gas atmosphere.

Further, a component force (see reference numeral “f” in FIG. 2) of the urging force acts on the holder rest shoulder of the housing radially inward in a direction parallel thereto. Furthermore, a reactive force (see reference numeral “F” in FIG. 2) acts on a contact surface between the packing element and the holder rest shoulder of the housing radially outward in a direction opposite to the component force. The present inventor has revealed that increasing the component force and the reactive force to respective adequate levels enables the prevention of a drop in hermetically sealing effect caused by impact shocks applied with the mounting tool during mounting operation of the gas sensor.

Therefore, with the present invention, by forming the holder rest shoulder in the housing at an opening angle less than 100°, the packing element can provide the component force and the reactive force with adequately increased levels, respectively. That is, increasing the component force and the reactive force to respective adequate levels enables the prevention of a drop in the hermetically sealing effect caused by impact shocks applied with the mounting tool during mounting operation of the gas sensor.

With the gas sensor according to the first aspect of the present invention, the holder rest shoulder of the housing may preferably have an opening angle greater than 45° with a view to enabling the packing element to be assembled in a stabilized manner. This is because of reasons described below.

That is, with the holder rest shoulder formed in the housing at the opening angle greater than 100°, there is a fear of a difficulty of ensuring a component force of an urging force acting on the holder rest shoulder in an axial direction of the gas sensor and a reaction force acting on a contact surface between the packing element and the holder rest shoulder in opposition to the component force. This results in a risk of the occurrence of a difficulty in adequately preventing a drop in a hermetically sealing effect caused by impact shocks during step of mounting the gas sensor to the exhaust pipe of the internal combustion engine through the use of a mounting tool.

As set forth above, the present invention makes it possible to provide a gas sensor that provides an increased hermetically sealing effect between the atmospheric side atmosphere and the measuring gas atmosphere.

Moreover, with the gas sensor of the structure mentioned above, the holder rest shoulder of the housing may preferably have a cross section formed in a straight line on the plane including the center axis of the gas sensor.

Such a structure enables the housing to be fabricated in an easy fashion without a need for executing complicated processing.

With the gas sensor of the structure mentioned above, the holder rest shoulder of the housing may preferably have a cross section formed in a curved line on the plane including the center axis of the gas sensor and the opening angle is defined by an angle formed with tangential lines passing through center portions of the holder rest shoulder of the housing.

With such a structure, the gas sensor can have increased hermetically sealing effect between the atmospheric side ambience and the measuring gas side ambience.

Also, the curved line may preferably be of the type having a single radius of curvature.

With the gas sensor set forth above, the insulating element holder may preferably include a large-diameter cylindrical body and a small-diameter cylindrical body between which the stepped engaging shoulder is formed in face-to-face relation with the holder rest shoulder of the housing, and the housing may preferably include a large-diameter cylindrical inner wall accommodating therein the large-diameter cylindrical body of the insulating element holder and a small-diameter inner peripheral wall accommodating therein the small-diameter cylindrical body of the insulating element holder wherein the holder rest shoulder is formed between the large-diameter cylindrical inner wall and the small-diameter inner peripheral wall.

Such a structure enables the insulating element holder and the housing to be fabricated in easy fashions so as to have the stepped engaging shoulder and the holder rest shoulder, respectively, with increased precisions to provide an improved hermetically sealing effect between the atmospheric side ambience and the measuring gas side ambience.

With the present embodiment, the gas sensor may preferably further comprises a spring member disposed between an annular shoulder of the housing and one end face of the insulating element holder for pressing the insulating element holder against the housing to press the packing element with the stepped engaging shoulder of the insulating element holder and the holder rest shoulder of the housing.

Such a structure enables the packing element to be pressed with a given pressure suitable for providing an improved hermetically sealing effect between the atmospheric side ambience and the measuring gas side ambience in a simplified structure.

With the gas sensor set forth above, the packing element may preferably include a base end portion disposed between an outer periphery of the insulating element holder and an inner peripheral wall of the housing in an area dislocated from the stepped engaging shoulder of the insulating element holder.

In this case, the gas sensor enables the base end portion of the packing element to be held in an increased tight contact with the inner peripheral wall of the housing. Therefore, the gas sensor can adequately prevent the occurrence of a drop in hermetically sealing effect between the atmospheric side ambience and the measuring gas side ambience resulting from impact shocks occurring when tightening the gas sensor onto the exhaust pipe using a mounting tool.

With the gas sensor set forth above, the base end portion of the packing element may preferably have a protruding portion extending from an edge of the holder rest shoulder of the housing by a distance greater than 0.3 mm.

With the packing element having the protruding portion in a protruding length greater than 0.3 mm from an edge of the holder rest shoulder of the housing, the gas sensor can have an increased hermetically sealing effect between the insulating element holder and the housing.

With the gas sensor set forth above, the packing element may preferably have hardness in a range from Hv100 to 200.

With the packing element with such hardness ranging from Hv100 to 200, the packing element can be uniformly deformed in a favorably fitting pattern between the stepped engaging shoulder of the insulating element holder and the holder rest shoulder of the housing to provide an increased hermetic sealing effect.

In a case where the hardness of the packing element is less than Hv100, uneven deformation takes place in the packing element with the resultant deterioration in a hermetically sealing effect between the atmospheric side ambience and the measuring gas side ambience. In addition, with the packing element having the hardness greater than Hv200, the packing element becomes hard to be favorably fitted to the stepped engaging shoulder of the insulating element holder and the holder rest shoulder of the housing in an adequate fashion. This results in a difficulty of ensuring the hermetic sealing effect between the atmospheric side ambience and the measuring gas side ambience.

Further, the hardness of the packing element takes a value that can be measured with a MicroVickers hardness tester with a value of Vickers hardness Hv (0.5) standardized under Japanese Industrial Standards Z2244.

With the gas sensor set forth above, the packing element may be preferably made of at least one material selected from the group including nickel, nickel alloy and stainless steel.

In such a case, it becomes to have an increased operating life because of the suppression of oxidation, corrosion and deteriorated durability of the packing element. This enables a gas sensor to be obtained with a structure having an increased hermetically sealing effect between the insulating element holder and the housing.

A second aspect of the present invention provides a gas sensor comprising a sensing element for detecting a concentration of specified gas in measuring gases, an insulating element holder internally supporting the sensing element and having an stepped engaging shoulder, a housing having first and second inner peripheral walls between which a plurality of holder rest shoulders are formed in face-to-face relation with the stepped engaging shoulder of the insulating element holder for internally supporting the insulating element holder, and a packing element interposed between the stepped engaging shoulder of the insulating element holder and the holder rest shoulders of the housing. An atmospheric side cover is fixedly connected to one end of the housing so as to cover a base end portion of the sensing element in an atmospheric side atmosphere, and a measuring gas side cover is fixedly connected to the other end of the housing so as to cover a leading end portion of the sensing element in a measuring gas atmosphere. At least one of the holder rest shoulders of the housing is formed in the housing at an opening angle less than 120°, representing an angle defined with a pair of profile lines in a cross section on a plane including a center axis of the gas sensor, which allows the packing element to hermetically seal the atmospheric side atmosphere and the measuring gas atmosphere from each other.

With such a structure of the gas sensor, the packing element is held in pressured contact between the stepped engaging shoulder of the insulating element holder and the holder rest shoulder of the housing. When this takes place, an urging force is exerted to the packing element toward a leading end of the gas sensor in an axial direction thereof. In this case, a component force of the urging force acts on the holder rest shoulder of the housing radially inward in a direction parallel thereto. Furthermore, a reactive force acts on a contact surface between the packing element and the holder rest shoulder of the housing radially outward in a direction opposite to the component force. The present inventor has revealed that increasing the component force and the reactive force to respective adequate levels enables the prevention of a drop in hermetically sealing effect caused by impact shocks applied with the mounting tool during mounting operation of the gas sensor.

Moreover, the housing has a crook portion formed on a boundary between the holder rest shoulders formed in the housing at differing opening angles. The present inventor has found that that the crook portion is effective to ensure a tight contact between the holder rest shoulders and the packing element.

Therefore, with at least one of the holder rest shoulders formed at the opening angle less than 120°, the housing can have the crook portion that allows the component force and the reactive force to have adequate magnitudes to ensure a tight contact between the holder rest shoulders and the packing element. This enables the prevention of a drop in a tight contact caused by impact shocks applied when turning the housing with a mounting tool during mounting operation of the gas sensor. This results in a capability of obtaining a gas sensor that has an increased hermetically sealing effect between the atmosphere side ambience and the measuring gas side ambience.

With the gas sensor according to the second aspect of the present invention, further, in a case where the holder rest shoulder of the housing has an opening angle greater than 120°, there is a fear of a difficulty of ensuring a component force of an urging force acting on the holder rest shoulder in an axial direction of the gas sensor and a reaction force acting on a contact surface between the packing element and the holder rest shoulder in opposition to the component force. Furthermore, a risk occurs with a difficulty in forming the crook portion in a boundary area between the element-holder shoulders 200, 202 formed at different opening angles.

Therefore, there is a fear of a difficulty of adequately preventing a drop in a hermetically sealing effect between the packing element and the holder rest shoulders when the packing element is applied with impact shocks in excess during step of mounting the gas sensor to the exhaust pipe of the internal combustion engine through the use of a mounting tool.

As mentioned above, the present invention makes it possible to provide a gas sensor that has an increased hermetically sealing effect between the atmosphere side ambience and the measuring gas side ambience.

A third aspect of the present invention provides a gas sensor comprising a sensing element for detecting a concentration of specified gas in measuring gases, an insulating element holder internally supporting the sensing element and having a large-diameter stepped engaging shoulder and a small-diameter stepped engaging shoulder, a housing having a large-diameter inner peripheral wall and a small-diameter inner peripheral wall between which a large-diameter holder rest shoulder and a small-diameter holder rest shoulder are formed in face-to-face relation with the large-diameter stepped engaging shoulder and the small-diameter stepped engaging shoulder of the insulating element holder, respectively, for internally supporting the insulating element holder, and a packing element interposed between the stepped engaging shoulders of the insulating element holder and the holder rest shoulders of the housing. An atmospheric side cover is fixedly connected to one end of the housing so as to cover a base end portion of the sensing element in an atmospheric side atmosphere, and a measuring gas side cover fixedly connected to the other end of the housing so as to cover a leading end portion of the sensing element in a measuring gas atmosphere. At least one of the holder rest shoulders of the housing is formed in the housing at an opening angle less than 120°, representing an angle defined with a pair of profile lines in a cross section on a plane including a center axis of the gas sensor, which allows the packing element to hermetically seal the atmospheric side atmosphere and the measuring gas atmosphere from each other.

With such a structure of the gas sensor according to the third aspect of the present invention, the insulating element holder has the large-diameter stepped engaging shoulder and the small-diameter stepped engaging shoulder. In addition, the housing has the large-diameter holder rest shoulder and the small-diameter holder rest shoulder formed in face-to-face relation with the large-diameter stepped engaging shoulder and the small-diameter stepped engaging shoulder of the insulating element holder, respectively. With such a structure, the packing element is held in pressured contact between the large-diameter stepped engaging shoulder and the small-diameter stepped engaging shoulder of the insulating element holder and the large-diameter holder rest shoulder and the small-diameter holder rest shoulder of the housing. When this takes place, an urging force is exerted to the packing element toward a leading end of the gas sensor in an axial direction thereof. In this case, the packing element is firmly retained with the insulating element holder and the housing with an increased hermetically sealing effect between the atmosphere side ambience and the measuring gas side ambience.

Moreover, the housing has a crook portion formed on a boundary between the holder rest shoulders formed in the housing at differing opening angles. The present inventor has found that that the crook portion is effective to ensure a tight contact between the holder rest shoulders and the packing element.

Therefore, with at least one of the holder rest shoulders formed at the opening angle less than 120°, the housing can have the crook portion that allows the component force and the reactive force to have adequate magnitudes to ensure a tight contact between the holder rest shoulders and the packing element. This enables the prevention of a drop in a tight contact caused by impact shocks applied when turning the housing with a mounting tool during mounting operation of the gas sensor. This results in a capability of obtaining a gas sensor that has an increased hermetically sealing effect between the atmosphere side ambience and the measuring gas side ambience.

A fourth aspect of the present invention provides a gas sensor comprising a sensing element for detecting a concentration of specified gas in measuring gases, an insulating element holder internally supporting the sensing element and having a large-diameter stepped engaging shoulder and a small-diameter stepped engaging shoulder, a housing having a large-diameter inner peripheral wall and a small-diameter inner peripheral wall between which an holder rest shoulder is formed in face-to-face relation with the large-diameter stepped engaging shoulder and the small-diameter stepped engaging shoulder of the insulating element holder, respectively, for internally supporting the insulating element holder, and a packing element interposed between the stepped engaging shoulders of the insulating element holder and the holder rest shoulders of the housing. An atmospheric side cover is fixedly connected to one end of the housing so as to cover a base end portion of the sensing element in an atmospheric side atmosphere, and a measuring gas side cover fixedly connected to the other end of the housing so as to cover a leading end portion of the sensing element in a measuring gas atmosphere. The holder rest shoulder is formed in the housing at an opening angle less than 120°, representing an angle defined with a pair of profile lines in a cross section on a plane including a center axis of the gas sensor, which allows the packing element to hermetically seal the atmospheric side atmosphere and the measuring gas atmosphere from each other. The packing element has a base end portion protruding to an area between the large diameter annular engaging shoulder of the insulating element holder and the large-diameter inner peripheral wall of the housing.

With such a structure of the gas sensor, the insulating element holder has the large-diameter stepped engaging shoulder and the small-diameter stepped engaging shoulder. In addition, the housing has the holder rest shoulder formed in face-to-face relation with the large-diameter stepped engaging shoulder and the small-diameter stepped engaging shoulder of the insulating element holder. With such a structure, the packing element is held in pressured contact between the large-diameter stepped engaging shoulder and the small-diameter stepped engaging shoulder of the insulating element holder and the holder rest shoulder of the housing. When this takes place, the packing element has a base end portion with a protruding portion sandwiched between the inner peripheral wall of the housing the large-diameter stepped engaging shoulder of the insulating element holder. This provides an increased hermetically sealing effect between the atmosphere side ambience and the measuring gas side ambience.

### BRIEF DESCRIPTION OF THE DRAWINGS

FIG. 1 is a cross sectional view of a gas sensor of a first embodiment according to the present invention.

FIG. 2 is a fragmentary enlarged cross sectional view showing forces acting on a boundary between a holder rest shoulder and a packing element.

FIG. 3 is a fragmentary enlarged cross sectional view showing a status wherein the packing element is intervened between the holder rest shoulder and the packing element.

FIG. 4 is a fragmentary enlarged cross sectional view showing a gas sensor of a second embodiment according to the present invention.

FIG. 5 is a fragmentary enlarged cross sectional view showing a gas sensor of a third embodiment according to the present invention.

FIG. 6 is a fragmentary enlarged cross sectional view showing a gas sensor of a fourth embodiment according to the present invention.

FIG. 7 is a graph showing the relationship between an opening angle of a holder rest shoulder of a housing and a gas leakage quantity obtained in Example 1.

FIG. 8 is a graph showing the relationship between an opening angle of a holder rest shoulder of a housing and a gas leakage quantity obtained in Example 2.

FIG. 9 is a graph showing the relationship between a protruding length of a packing element and a gas leakage quantity obtained in Example 3.

FIG. 10 is a graph showing the relationship between a hardness of a packing element and a gas leakage quantity obtained in Example 4.

FIG. 11 is a cross sectional view of a gas sensor of a related art.

### DETAILED DESCRIPTION OF PREFERRED EMBODIMENTS

Now, gas sensors of various embodiments according to the present invention are described below in detail with reference to the accompanying drawings. However, the present invention is construed not to be limited to such embodiments described below and technical concepts of the present invention may be implemented in combination with other known technologies or the other technology having functions equivalent to such known technologies.

In the following description, like reference characters designate like or corresponding parts throughout the several views. Also, in the following description, it is construed that a portion of a gas sensor adapted to be inserted to an exhaust pipe of an internal combustion engine of a motor vehicle is referred to as a “leading end” or a “distal end” and an opposite side of the gas sensor exposed to an atmosphere is referred to as a “base end” or a “base end portion”.

Also, it will be appreciated that the gas sensors of various embodiment according to the present invention may have a wide variety of applications to an oxygen sensor, an A/F sensor, a NOx sensor, etc.

### First Embodiment

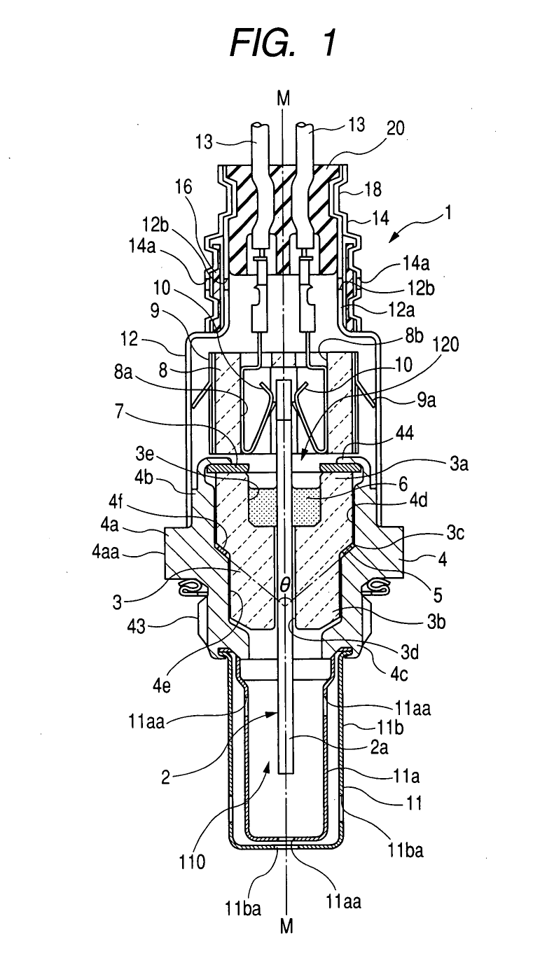

A gas sensor of a first embodiment according to the present invention is described below in detail with reference to FIGS. 1 to 3.

As shown in FIG. 1, a gas sensor 1 of the present embodiment comprises a gas sensing element 2 for detecting a concentration of specified gas in measuring gases, an insulating element holder 3 with which the gas sensing element 2 is internally held in a fixed place, and a housing 4 internally holding the insulating element holder 3.

As shown in FIG. 1, the housing 4 includes a housing body 4a having its outer periphery formed with a tool-fitting portion 4aa adapted to allow the gas sensor 1 to be mounted on a wall of, for instance, an exhaust pipe of an internal combustion engine for exhaust gases to be detected, an upper cylindrical body 4b extending from the housing body 4a upward and acting as a base end portion, and a lower cylindrical body 4c extending from the housing body 4a downward and acting as a leading end portion. The tool-fitting portion 4aa is formed in a substantially hexagonal profile with two facing surfaces of hexagonal surfaces being distanced from each other by 22 mm.

Further, the housing 4 has a threaded portion 43, formed on an outer periphery of the lower cylindrical body 4c, with which the gas sensor 1 is mounted on the wall of the exhaust pipe. The housing 4 is internally formed with a first large diameter inner wall 4d and a second small diameter inner wall 4e, with an holder rest shoulder 4f being formed between the first and second inner walls 4d, 4e.

The insulating element holder 3 includes a large diameter cylindrical body 3a and a small diameter cylindrical body 3b, with an stepped engaging shoulder 3c being formed between the first and second cylindrical bodies 3a, 3b. The insulating element holder 3 also has a central bore 3d, through which the gas sensing element 2 extends in an axial direction of the gas sensor 1, and a cylindrical cavity 3e formed in the large diameter cylindrical body 3a and filled with glass sealant 6. Glass sealant 6 provides a sealing effect to prevent measuring gases from leaking through a clearance between the gas sensing element 2 and the small diameter cylindrical body 3b of the insulating element holder 3 to an upper area of the insulating element holder 3.

The insulating element holder 3 is accommodated in the housing 4 such that the large diameter cylindrical body 3a is inserted to the large diameter inner wall 4d of the housing 4 and the small diameter cylindrical body 3b is inserted to the small diameter inner wall 4e of the housing 4 with a packing element 5 being interposed between the stepped engaging shoulder 3c of the insulating element holder 3 and the holder rest shoulder 4f of the housing 4 to provide a sealing effect.

The packing element 5 separates a measuring gas side ambience 110 and an atmospheric side ambience 120 from each other in the gas sensor 1 in a hermetically sealing effect.

The holder rest shoulder 4f of the housing 4 is formed in the housing 4 at an opening angle “θ” representing an angle defined with a pair of profile lines appearing on a plane including a center axis M of the gas sensor 1 in a cross section thereof and set to be less than 100°.

As shown in FIG. 1, further, the gas sensor 1 further includes a ring-like spring 7 that is interposed between an inwardly extending shoulder 44 of the upper cylindrical body 4b of the housing 4 and an upper end face of the insulating element holder 3 to urge the insulating element holder 3 against the housing 4 with a given urging force.

The gas sensor 1 of the present embodiment is further described in detail hereinafter.

The gas sensor 1 of the present embodiment has application to a motor vehicle and is mounted on an exhaust pipe of an internal combustion engine of the motor vehicle with a view to executing combustion control of the internal combustion engine. In such application, the gas sensor 1 of the present embodiment plays a role as, for instance, an O₂ sensor, an A/F sensor, NOx sensor, etc.

The gas sensor 1 of the present embodiment comprises, in addition to the gas sensing element 2, the insulating element holder 3 and the housing 4, an atmospheric side insulator 8, a measuring gas side cover 11 fixedly mounted on an end face of the lower cylindrical body 4c of the housing 4, and an atmospheric side cover 12 fixedly mounted on the upper cylindrical body 4b of the housing 4 by welding. The atmospheric side ambience 120 is defined in the atmospheric side cover 12 and the measuring gas side ambience 110 is defined in the measuring gas side cover 11.

The atmospheric side insulator 8 is embedded in a protective casing 9 having outwardly extending retainer segments 9a held in abutting engagement with an inner periphery of the atmospheric side cover 12 for placement in fixed place. The atmospheric side insulator 8 has an axially extending cavity 8a that accommodates therein spring terminals 10, 10 held in electrical contact with electrode terminals (not shown) of the gas sensing element 2. The spring terminals 10, 10 are electrically connected to lead wire portions 13, 13.

The atmospheric side cover 12 has an upwardly extending base end section 12a having a plurality of ventilation openings 12b formed at circumferentially spaced positions. The base end section 12a of the atmospheric side cover 12 carries thereon an outer cover 14 formed with a plurality of ventilation openings 14a at circumferentially spaced positions in radial alignment with the ventilation openings 12b formed on the base end section 12a of the atmospheric side cover 12 to introduce atmospheric air into the atmospheric side ambience 120.

A ventilation filer 16 is interposed between the base end section 12a of the atmospheric side cover 12 and the outer cover 14 in a position to provide a waterproof function between the ventilation openings 14a of the outer cover 14 and the ventilation openings 12b of the base end section 12a of the atmospheric side cover 12 while admitting atmospheric air to an inside of the atmospheric side cover 12.

As shown in FIG. 1, furthermore, the base end section 12a of the atmospheric side cover 12 and the outer cover 14 are coupled to each other at a caulked portion 18 with which a rubber bush 20 is fixedly supported. With such a configuration, the rubber bush 20 allows the base end of the gas sensing element 2 to have a waterproof function. The rubber bush 20 internally supports the lead wire portions 13, 13, which are electrically connected to the electrode terminals 10 of the gas sensing element 2.

The measuring gas side cover 11 takes a double-layer structure that includes an inner protecting cover 11a, formed with a plurality of openings 11 aa, and an outer protecting cover 11b having a plurality of openings 11ba. Thus, the openings 11aa, 11ba play roles as gas flow ports through which measuring gases are introduced to an inside of the measuring gas side cover 11 in contact with a detecting section 2a of the gas sensing element 2.

When assembling the insulating element holder 3 to the housing 4, the gas sensing element 2 is inserted through and fixedly supported with the insulating element holder 3 and the lower small diameter cylindrical body 3b of the insulating element holder 3 is then inserted through the packing element 5. Subsequently, the insulating element holder 3 and the packing element 5 are inserted through the housing 4 such that the upper cylindrical body 3a passes through the inner wall 4d of the housing 4 and the lower cylindrical body 3b passes through the inner wall 4e of the housing 4 with the packing element 5 being sandwiched between the stepped engaging shoulder 3c of the insulating element holder 3 and the holder rest shoulder 4f of the housing 4.

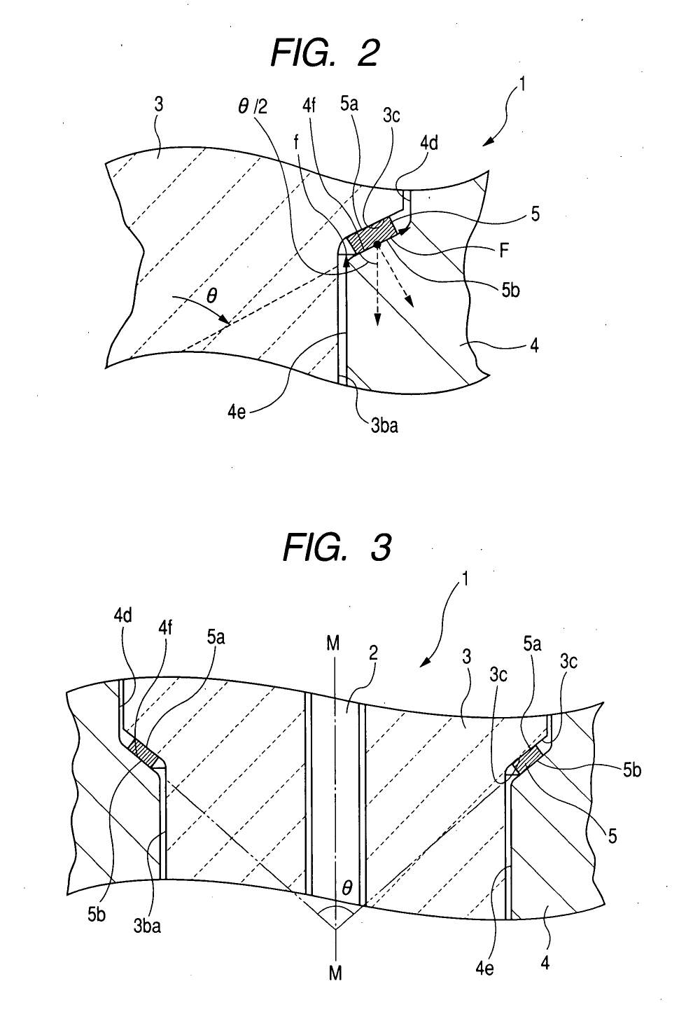

With such a condition, the packing element 5 has a base end face 5a held in abutting engagement with the stepped engaging shoulder 3c of the insulating element holder 3 and a leading end face 5b held in abutting engagement with the holder rest shoulder 4f of the housing 4 as shown in FIGS. 2 and 3.

Then, the ring-like spring 7 is held in fixed place on the upper end face of the insulating element holder 3 with the annular shoulder 44 of the housing 5 to allow the insulating element holder 3 to be pressed against the housing 4 with the given urging force. When this takes place, the insulating element holder 3 and the housing 4 are held in tight contact with each other by means of the packing element 5 sandwiched between the stepped engaging shoulder 3c of the insulating element holder 3 and the holder rest shoulder 4f of the housing 4. In such a way, the packing element 5 allows the measuring gas side ambience 110 and the atmospheric side ambience 120 to be hermetically separated from each other.

With the gas sensor 1 of the present embodiment, the packing element 5 is made of suitable metallic material such as nickel, nickel alloy and stainless steel (SUS430) with hardness of Hv100 to 200. In addition, the packing element 5 has a size with, for instance, an inner diameter φ1 of 13 mm and an outer diameter φ2 of 15.5 mm with a thickness of 0.4 mm.

Further, the holder rest shoulder 4f of the housing 4 has a cross section formed in a straight line on a plane including the center axis M of the gas sensor 1 as shown in FIGS. 1 to 3.

As shown in FIG. 1, further, the cavity 3e of the insulating element holder 3 is filled with glass sealant 6 to provide a hermetically sealing effect between the insulating element holder 3 and the gas sensing element 2. Glass sealant 6 allows the atmospheric side ambience 120 and the measuring gas side ambience 110 inside the gas sensor 1 to be hermetically sealed off from each other in the same way as the packing element 5.

Thus, with the gas sensor 1 of the present embodiment, the packing element 5 and glass sealant 6 hermetically seal off the atmospheric side ambience 120 and the measuring gas side ambience 110 from each other. This enables the gas sensing element 2 to detect a concentration of specified gas in measuring gases with high precision.

With the gas sensor 1 of the present embodiment set forth above, the insulating element holder 3 is press downward, that is, toward a distal end of the gas sensor 1 with the action of the ring-shaped spring 7 fixedly held with the annular shoulder 44 of the housing 4. When this takes place, the stepped engaging shoulder 3c of the insulating element holder 3 is pressed against the holder rest shoulder 4f of the housing 4 via the packing element 5.

Under such a state, as shown in FIG. 2, a component force “f” of the urging force acts on the holder rest shoulder 4f of the housing 4 in parallel thereto and in radially inward direction. Moreover, a reactive force “F” acts on the leading end face 5b of the packing element 5 as a reaction against the component force “f” in a radially outward direction.

When mounting the gas sensor 1 of the present embodiment on an exhaust pipe of an internal combustion of a motor vehicle, the measuring gas side cover 11 of the gas sensor 1 is inserted to an inside of the exhaust pipe of the engine, after which the housing 4 is turned with an impact wrench engaging the tool-fitting portion 4aa of the housing 4. This causes the threaded portion 43, formed on the outer periphery of the lower cylindrical body 4c of the housing 4, to be screwed into a threaded bore formed in the wall of the exhaust pipe, and the gas sensor 1 is fixedly mounted on and tightened onto the wall of the exhaust pipe.

The gas sensor 1 of the present embodiment has various advantageous effects as listed below.

As shown in FIGS. 1 to 3, the holder rest shoulder 4f has the opening angle θ less than 100°. This allows the packing element 5 of the gas sensor 1 to have an increased hermetically sealing effect to interrupt fluid communication between the atmospheric side ambience 120 and the measuring gas side ambience 110.

That is, the ring-shaped spring 7, fixed in place with the annular shoulder 44 of the housing 4, urges the packing element 5 against the holder rest shoulder 4f of the housing 4 in an axial direction of the gas sensor 1. This allows the packing element 5 to be tightly held in contact with the stepped engaging shoulder 3c of the insulating element holder 3 and the holder rest shoulder 4f of the housing 4 via the packing element 5.

Thus, the atmospheric side ambience 120 and the measuring gas side ambience 110 can be hermetically separated from each other. Under such a condition, as shown in FIG. 2, the force component “f” of the urging force of the spring 7 acts on the holder rest shoulder 4f of the housing 4 in parallel thereto in a direction directed radially inward. Therefore, the reactive force “F” acts on the leading end face 5b of the packing element 5 as the reaction against the component force “f” in the radially outward direction.

The inventor has found out that increasing the component force “f” and the reactive force “F” to respective adequate levels enables the prevention of a drop in hermetically sealing effect resulting from impact shocks occurred during mounting step of the gas sensor 1 with the use of a mounting tool.

Thus, by forming the holder rest shoulder 4f of the housing 4 at the opening angle θ less than 100°, it becomes possible to ensure the component force “f” and the reactive force “F” with respective adequate values as shown in FIG. 2. That is, with the component force “f” and the reactive force “F” selected to have adequately large values, it becomes possible to prevent deterioration in a hermetically sealing effect caused by impact shocks occurring during mounting step of the gas sensor 1 with the use of a mounting tool. Therefore, the gas sensor 1 of the present embodiment can have an excellent hermetically sealing effect between the atmospheric side ambience 120 and the measuring gas side ambience 110.

As shown in FIGS. 1 to 3, further, the holder rest shoulder 4f of the housing 4 is formed in the straight line on a cross section of the gas sensor 1 on a plane including the center axis M thereof. Thus, the housing 4 can be easily fabricated to have the first and second inner peripheral walls 4d, 4e with the holder rest shoulder 4f formed therebetween without causing any complicated processing to be executed.

Further, since the packing element 5 has hardness in a range from Hv100 to 200, the packing element 5 can be uniformly deformed in an adequately fitted pattern between the holder rest shoulder 4f of the housing 4 and the stepped engaging shoulder 3c of the insulating element holder 3.

Furthermore, since the packing element 5 is made of stainless steel, the packing element 5 can suppress the occurrence of oxidation, corrosion and deteriorated durability even under real car ambiences. This results in a capability of obtaining a gas sensor 1 having an increased hermetically sealing effect between the atmospheric side ambience 120 and the measuring gas side ambience 110.

As set forth above, the present invention makes it possible to provide a gas sensor having an increased hermetically sealing effect between the atmospheric side ambience 120 and the measuring gas side ambience 110.

### Second Embodiment

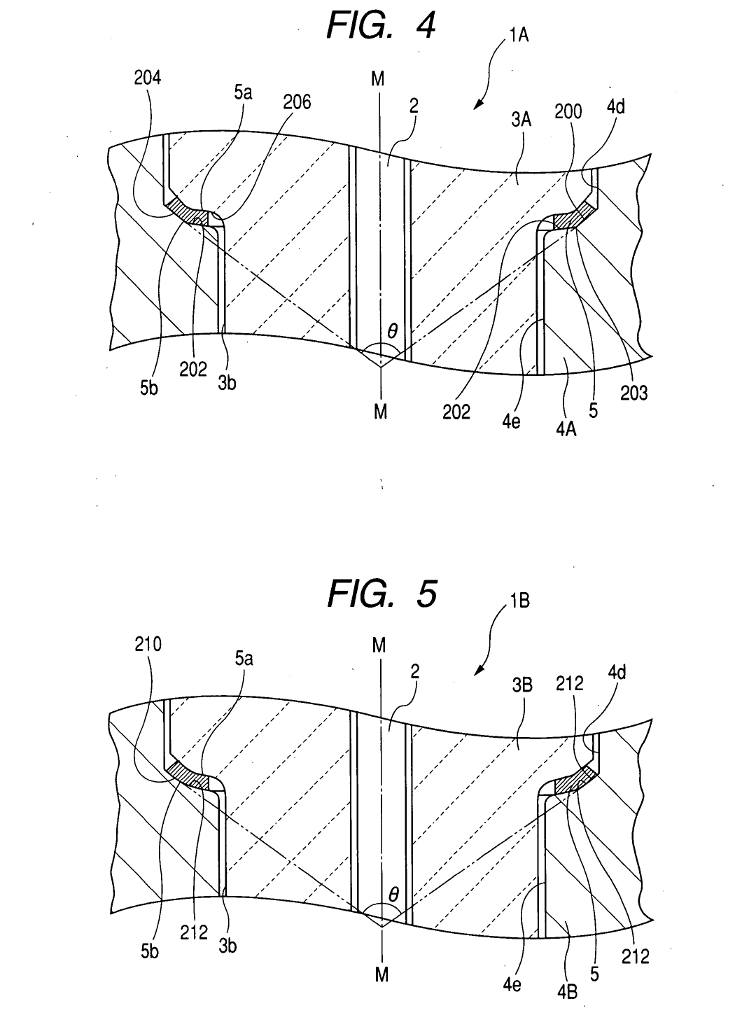

A gas sensor 1A of a second embodiment according to the present invention is described below with reference to FIG. 4.

With the gas sensor 1A of the present embodiment, a housing 4A has a large diameter holder rest shoulder 200 contiguous with an inner peripheral wall 4d of the housing 4A and a small diameter holder rest shoulder 202 having one end contiguous with the first holder rest shoulder 200 and the other end contiguous with an inner peripheral wall 4e of the housing 4A. The first and second holder rest shoulders 200, 202 are formed at an obtuse angle with an intermediate portion formed in a crook portion 203. The insulating element holder 3 has a large-diameter engaging shoulder 204 and a small-diameter engaging shoulder 206, both of which are formed in a bend pattern substantially in parallel to the first and second holder rest shoulders 200, 202, respectively.

The large diameter holder rest shoulder 200 of the housing 4A is formed at an opening angle θ less than 120° representing an angle defined with a pair of profile lines extending on a plane including the center axis M of the gas sensor 1A in a cross section thereof. Meanwhile, the small diameter holder rest shoulder 202 of the housing 4A is formed at an opening angle θ of, for instance, approximately 150°.

In addition, the first and second holder rest shoulders 200, 202 are formed on straight lines, respectively. The gas sensing element 1A of the present embodiment has the same other structure as that of the gas sensor 1 shown in FIG. 1 and, hence, the description of the same component parts is herein omitted for the sake of simplicity.

The gas sensor 1A of the present embodiment has various advantageous effects as described below.

With the insulating element holder 3A press fitted against the housing 4A, the packing element 5 is compressed with an urging force of the spring 7 (see FIG. 1) between the first and second stepped engaging shoulders 204, 206 of the insulating element holder 3A and the first and second holder rest shoulders 200, 202 of the housing 4A. When this takes place, a force component of the urging force of the spring 7 acts on the holder rest shoulder 200 of the housing 4 in parallel to the holder rest shoulder 200 in a direction directed radially inward. In addition, a reactive force acts on the leading end face 5b of the packing element 5 in parallel to the holder rest shoulder 200 as a reaction against the component force in the radially outward direction. The present inventor has revealed that under such a condition, adjusting the component force and the reactive force to increased levels enables the prevention of a drop in hermetically sealing effect resulting from impact shocks occurred during mounting step of the gas sensor 1 with the use of a mounting tool.

Further, the crook portion 203 is provided on a boundary between the large diameter holder rest shoulder 200 and the small diameter holder rest shoulder 202, both of which are formed at different opening angles. The present inventor has also revealed that such a crook portion 203 is effective to retain the packing element 5 in a fixed place with increased adhesion between the packing element 5 and the first and second holder rest shoulders 200, 202.

Therefore, in a case where the opening angle θ is set to be less than 120°, the gas sensor 1A can have the component force and the reactive force with respective increased levels and the crook portion 203 that can ensure adequate adhesion between the packing element 5 and the first and second annular shoulder holder rest shoulders 200, 202. This enables the prevention of a drop in hermetically sealing effect resulting from impact shocks caused during mounting step with the use of a mounting tool, enabling the provision of a gas sensor 1A with increased hermetically sealing effect between the atmospheric side ambience 120 and the measuring gas side ambience 110.

The gas sensor 1A of the present embodiment has the other advantageous effects as those of the gas sensor 1 of the first embodiment shown in FIG. 1 and, hence, the description of the same is herein omitted.

Also, it will be appreciated that the present invention is not limited to such a particular structure mentioned above and various other modifications may be implemented. For instance, the gas sensor 1A may be altered such that the small diameter holder rest shoulder 202 is formed at an opening angle with a value less than that of the large diameter holder rest shoulder 200 to allow the small diameter holder rest shoulder 202 to be formed at the opening angle less than 120°.

Further, the housing 4A may have more than three holder rest shoulders defined at different opening angles. In another alternative, the housing 4A may have a holder rest shoulder formed in a curved profile.

### Third Embodiment

A gas sensor 1B of a third embodiment according to the present invention is described below with reference to FIG. 5.

With the gas sensor 1B of the present embodiment, a housing 4B has a holder rest shoulder 212 contiguous with the inner peripheral wall 4d of the housing 4B and the inner peripheral wall 4e of the housing 4B. The insulating element holder 3B has a curved engaging shoulder 210 formed in face-to-face relationship with the curved holder rest shoulder 212 of the housing 4B.

The curved holder rest shoulder 212 of the housing 4B is formed in the housing 4B so as to allow a tangential line of the curved holder rest shoulder 212 to be aligned at an opening angle θ less than 100°.

### Fourth Embodiment

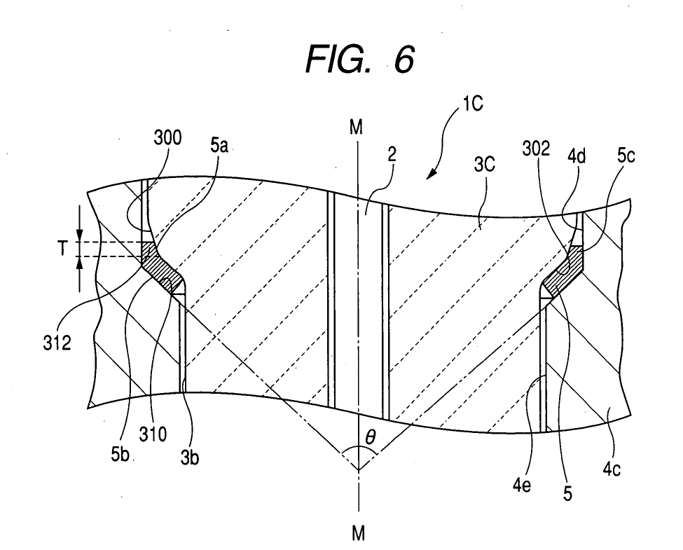

A gas sensor 1C of a fourth embodiment according to the present invention is described below with reference to FIG. 6.

With the gas sensor 1C of the present embodiment, a housing 4C has an holder rest shoulder 310 formed at a given opening angle. The insulating element holder 3C has a large-diameter engaging shoulder 300 and a small-diameter engaging shoulder 302, with the large-diameter engaging shoulder 300 intersecting an inner peripheral wall 4d of the housing 4C at an acute angle while the small-diameter engaging shoulder 302 extending substantially parallel to the holder rest shoulder 310 of the housing 4C.

With the gas sensor 1C mentioned above, an annular space 312 is provided between the large-diameter stepped engaging shoulder 300 of the insulating element holder 3C and the inner peripheral wall 4d of the housing 4C. With the insulating element holder 3C assembled to the housing 4C, the packing element 5 has a base end portion 5c that is accommodated in the annular space 312. The base end portion 5c of the packing element 5 protrudes into the annular space 312 by a length greater than 0.3 mm from an upper edge of the holder rest shoulder 310 of the housing 4C.

The gas sensor 1C of the present embodiment has the same other structure as that of the gas sensor 1 of the first embodiment shown in FIG. 1.

With the gas sensor 1C of the present embodiment, the base end portion 5c of the packing element 5 protrudes into the annular space 312 by a length greater than 0.3 mm from the upper edge of the stepped engaging shoulder 302, providing increased adhesion between the inner peripheral wall 4d of the housing 4C and the base end portion 5c of the packing element 5.

### EXAMPLE 1

Various test pieces on gas sensors were prepared with structures having single holder rest shoulders formed at different opening angles θ. Impact shocks were applied to the test pieces on the housings thereof and the degrees of hermetically sealing performance of packing elements were measured, with test results being plotted in FIG. 6.

Also, the component parts of the test pieces bear like reference numerals pursuant to those used in the gas sensor 1 shown in FIG. 1.

For measuring the hermetically sealing performances, gas sensors were prepared as the test pieces with structures each formed with a housing 4 having a single holder rest shoulder formed at different opening angles θ. That is, four kinds of test pieces were prepared with the opening angles θ being set to 80°, 100°, 120° and 150°, respectively. Moreover, four samples were prepared for each test piece.

Also, the packing elements 5 had hardness of Hv120.

Impact shocks were applied to the test pieces and, thereafter, the hermetically sealing effects of the test pieces between atmosphere ambiences 120 and measuring gas side ambiences 110 were measured. The hermetically sealing effects of the test pieces were evaluated in two phases including one phase before tool fitting portions 4aa of the housings 4 of the test pieces were turned with a mounting tool such as an impact wrench and the other phase after the tool fitting portions 4aa of the housings 4 were turned with the mounting tool.

In evaluating the hermetically sealing performances of the test pieces, tests were conducted upon placing the test pieces on a hermetic sealing evaluation tester provided with a chamber maintained under a measuring gas atmosphere at the nearly same pressure (of 0.4 MPa) as that of a real car environment after which measurements were conducted to check the amount of gas leaked from the measuring gas side ambience 110 to the atmosphere ambience 120 in each test piece per unit time.

During tests, initially, a gas leakage quantity of each test piece was measured using the hermetic sealing evaluation tester under a condition before each sample is applied with shock impacts. Subsequently, the tool-fitting portion 4aa of each sample was turned with the impact wrench to cause each sample to be tightened and fixed to a dummy jig. Then, each sample was taken out of the jig and the gas leakage quantity was measured again with the hermetic sealing evaluation tester after the impact shocks were applied to each sample.

Prior to the application of impact shocks, each sample substantially had almost no gas leakage with the gas leakage quantity falling in a value less than 0.01 cc/minute.

FIG. 7 shows measured results on gas leakage quantities of the samples subsequent to impact shocks being applied.

It is turned out from FIG. 7 that with the structures having the holder rest shoulders formed at the opening angles θ in values of 80° and 100°, the samples had minimal gas leakage quantities to be less than 1 cc/min even when applied with the impact shocks. In addition, it is turned out that with the samples wherein the holder rest shoulders had the opening angles θ in values of 120° and 150°, the samples had increased gas leakage quantities falling in a value greater than 2 cc/min.

That is, it can be said that with the gas sensors including the housings each having the holder rest shoulder formed at the opening angle θ less than 100°, each gas sensor can ensure tightly contact states between the holder rest shoulder 4f and the packing element 5 and between the stepped engaging shoulder 3c and the packing element 5 for thereby preventing gas from leaking from the measuring gas side ambience 110 to the atmospheric side ambience 120.

### EXAMPLE 2

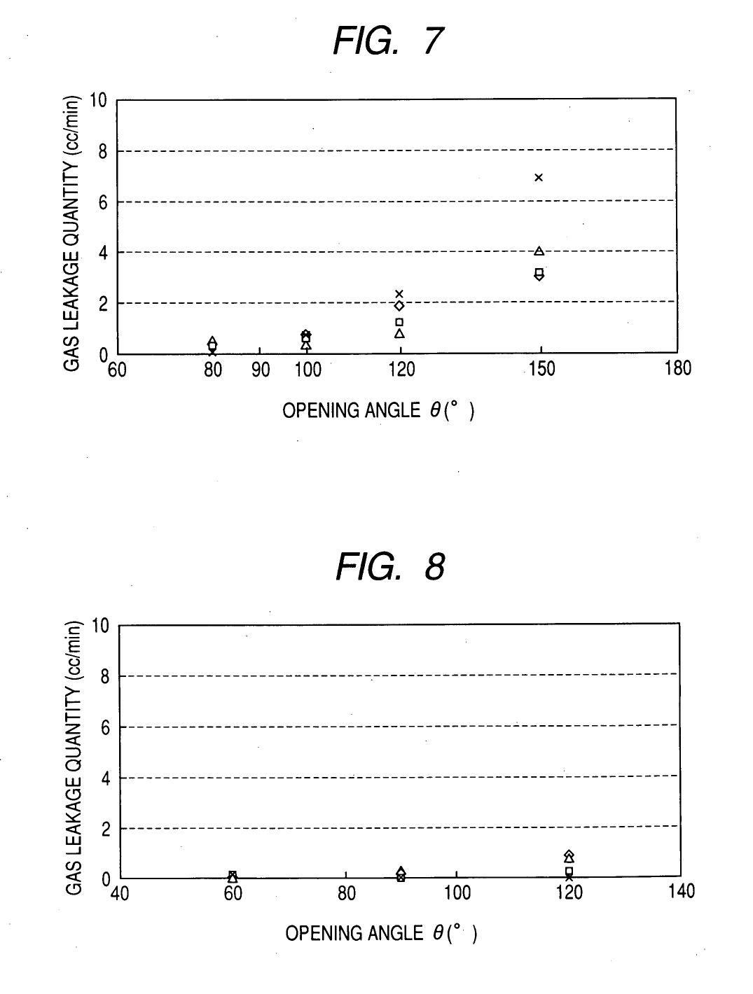

Various test pieces on gas sensors for Example 2 were prepared with structures having composite holder rest shoulders formed at different opening angles θ. Housings of the test pieces were applied with impact shocks and hermetically sealing performances of packing elements were measured with test results being plotted in FIG. 8.

Also, the component parts of the test pieces bear like reference numerals pursuant to those used in the gas sensor 1 shown in FIG. 4.

For measuring hermetically sealing performances, gas sensors were prepared as the test pieces with structures including housings 4 having composite holder rest shoulders each including a large-diameter holder rest shoulder 200 and a small-diameter holder rest shoulder 202 (see FIG. 4) formed at opening angles θ in different values. That is, three kinds of test pieces were prepared with the opening angles θ being set to values of 60°, 90° and 120°, respectively. Moreover, the small-diameter element rest holders 202 of the samples were fixed at a value of 150°. In addition, four gas sensors were prepared for each test piece.

Also, the packing elements 5 had hardness of Hv120.

FIG. 8 shows measurement results on gas leakage quantities of the samples subsequent to impact shocks being applied.

As will be apparent from FIG. 8, both of the samples had a minimal gas leakage quantity to be less than 1 cc/min even after the samples were applied with the impact shocks.

That is, it will be understood that even with the gas sensors having the housing formed with the plural holder rest shoulders 200, 202, the present invention can provide favorable advantageous effects provided that the large-diameter holder rest shoulders 200 are formed at the opening angles θ less than 120°.

### EXAMPLE 3

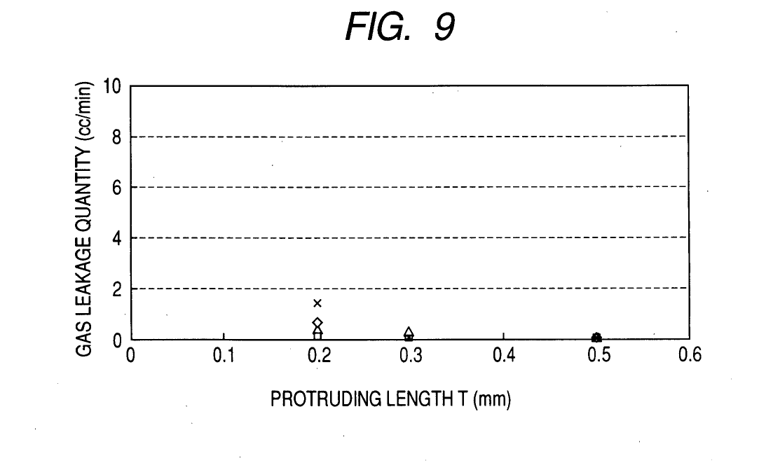

Various test pieces on gas sensors for Example 3 were prepared with structures having composite engaging shoulders 300, 302 associated with packing elements 5 with base end portions 312 protruding in various protruding lengths T. Housings of the test pieces were applied with impact shocks and hermetically sealing performances of packing elements were measured with test results being plotted in FIG. 9.

Also, the component parts of the test pieces bear like reference numerals pursuant to those used in the gas sensor 1 shown in FIG. 6.

In this Example 3, three kinds of test pieces were prepared with packing elements 5 having base end portions Sc protruding into the annular spaces 312 in protruding lengths T of 0.2 mm, 0.3 mm and 0.5 mm. Moreover, the test pieces had housings 4C formed with holder rest shoulders 310 fixed at an opening angle θ of 100°. In addition, four samples were prepared for each test piece.

Also, the packing elements 5 had hardness of Hv120.

The samples had the same other structures as those of the gas sensor 1 shown in FIG. 1.

FIG. 9 shows measured results on gas leakage quantities of the samples subsequent to impact shocks being applied.

As will be apparent from FIG. 9, both of the samples had a minimal gas leakage quantity to be less than 1 cc/min even when applied with the impact shocks provided that the packing elements 5 had the protruding length T greater than 0.3 mm.

### EXAMPLE 4

Various tests were conducted on the gas sensors (see FIG. 4) on Example 2 to check the relationship between hardness of the packing elements 5 and the gas leakage quantities.

In Example 4, the gas sensors were prepared as test pieces with structures employing the packing elements 5 with hardness varied in a range from Hv50 to 250.

Hardness of the packing elements 5 were measured with a test force of 4.903N using a MicroVickers hardness tester with hardness Hv (0.5) standardized under JIS Z2244.

Further, with the gas sensors, the housings 4A had the large-diameter holder rest shoulders 200 formed at a fixed opening angle θ of 120°.

Each of the samples had the same other structure as that of the gas sensor 1 shown in FIG. 1.

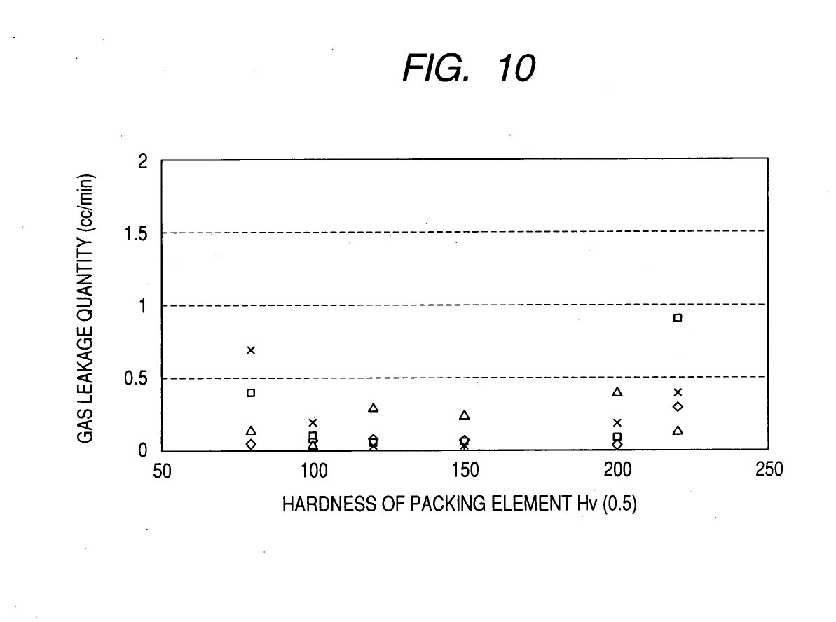

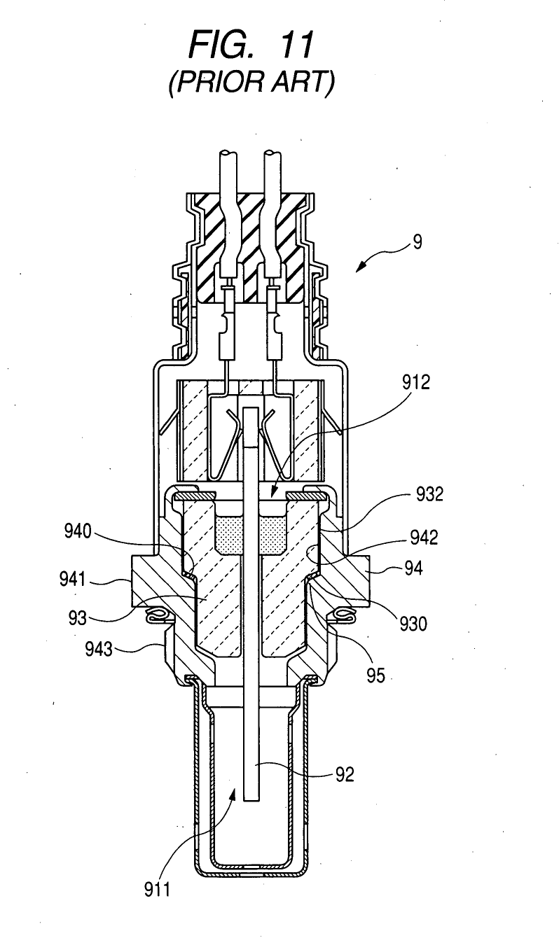

FIG. 10 shows measured results on gas leakage quantities of the samples subsequent to impact shocks being applied.

As will be apparent from FIG. 10, both of the samples had a minimal gas leakage quantity to be less than 0.5 cc/min even when applied with the impact shocks provided that the packing elements 5 had hardness in a range from Hv100 to 200. In contrast, those of the samples provided with the packing elements 5 having hardness less than Hv100 and the packing elements 5 having hardness greater than Hv200 had gas leakage quantities greater than 0.5 cc/min with no favorable success in suppressing the gas leakages.

While the specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention, which is to be given the full breadth of the following claims and all equivalents thereof.

What is claimed is:

1. A gas sensor comprising:
a sensing element for detecting a concentration of specified gas in measuring gases;
an insulating element holder internally supporting the sensing element and having an stepped engaging shoulder;
a housing having first and second inner peripheral walls between which an holder rest shoulder is formed in face-to-face relation with the stepped engaging shoulder of the insulating element holder for internally supporting the insulating element holder;
a packing element interposed between the stepped engaging shoulder of the insulating element holder and the holder rest shoulder of the housing;
an atmospheric side cover fixedly connected to one end of the housing so as to cover a base end portion of the sensing element in an atmospheric side atmosphere; and
a measuring gas side cover fixedly connected to the other end of the housing so as to cover a leading end portion of the sensing element in a measuring gas atmosphere;
wherein the holder rest shoulder is formed in the housing at an opening angle less than 100°, representing an angle defined with a pair of profile lines in a cross section on a plane including a center axis of the gas sensor, which allows the packing element to hermetically seal the atmospheric side atmosphere and the measuring gas atmosphere from each other.

2. The gas sensor according to claim 1, wherein:
the holder rest shoulder of the housing has a cross section formed in a straight line on the plane including the center axis of the gas sensor.

3. The gas sensor according to claim 1, wherein:
the holder rest shoulder of the housing has a cross section formed in a curved line on the plane including the center axis of the gas sensor and the opening angle is defined by an angle formed with tangential lines passing through center portions of the holder rest shoulder of the housing.

4. The gas sensor according to claim 1, wherein:
the insulating element holder includes a large-diameter cylindrical body and a small-diameter cylindrical body between which the stepped engaging shoulder is formed in face-to-face relation with the holder rest shoulder of the housing; and
the housing includes a large-diameter cylindrical inner wall accommodating therein the large-diameter cylindrical body of the insulating element holder and a small-diameter inner peripheral wall accommodating therein the small-diameter cylindrical body of the insulating element holder wherein the holder rest shoulder is formed between the large-diameter cylindrical inner wall and the small-diameter inner peripheral wall.

5. The gas sensor according to claim 4, further comprising:
a spring member disposed between an annular shoulder of the housing and one end face of the insulating element holder for pressing the insulating element holder against the housing to press the packing element with the stepped engaging shoulder of the insulating element holder and the holder rest shoulder of the housing.

6. The gas sensor according to claim 1, wherein:
the packing element includes a base end portion disposed between an outer periphery of the insulating element holder and an inner peripheral wall of the housing in an area dislocated from the stepped engaging shoulder of the insulating element holder.

7. The gas sensor according to claim 6, wherein:
the base end portion of the packing element has a protruding portion extending from an edge of the holder rest shoulder of the housing by a distance greater than 0.3 mm.

8. The gas sensor according to claim 1, wherein:
the packing element has a hardness in a range from Hv100 to 200.

9. The gas sensor according to claim 1, wherein:
the packing element is made of at least one material selected from the group including nickel, nickel alloy and stainless steel.

10. A gas sensor comprising:
a sensing element for detecting a concentration of specified gas in measuring gases;
an insulating element holder internally supporting the sensing element and having an stepped engaging shoulder;
a housing having first and second inner peripheral walls between which a plurality of holder rest shoulders are formed in face-to-face relation with the stepped engaging shoulder of the insulating element holder for internally supporting the insulating element holder;
a packing element interposed between the stepped engaging shoulder of the insulating element holder and the holder rest shoulders of the housing;
an atmospheric side cover fixedly connected to one end of the housing so as to cover a base end portion of the sensing element in an atmospheric side atmosphere; and
a measuring gas side cover fixedly connected to the other end of the housing so as to cover a leading end portion of the sensing element in a measuring gas atmosphere;
wherein at least one of the holder rest shoulders of the housing is formed in the housing at an opening angle less than 120°, representing an angle defined with a pair of profile lines in a cross section on a plane including a center axis of the gas sensor, which allows the packing element to hermetically seal the atmospheric side atmosphere and the measuring gas atmosphere from each other.

11. The gas sensor according to claim 10, wherein:
the insulating element holder includes a large-diameter cylindrical body and a small-diameter cylindrical body between which the stepped engaging shoulder is formed in face-to-face relation with the holder rest shoulders of the housing; and
the housing includes a large-diameter cylindrical inner wall accommodating therein the large-diameter cylindrical body of the insulating element holder and a small-diameter inner peripheral wall accommodating therein the small-diameter cylindrical body of the insulating element holder wherein the holder rest shoulders are formed between the large-diameter cylindrical inner wall and the small-diameter inner peripheral wall.

12. The gas sensor according to claim 11, further comprising:
a spring member disposed between an annular shoulder of the housing and one end face of the insulating element holder for pressing the insulating element holder against the housing to press the packing element with the stepped engaging shoulder of the insulating element holder and the holder rest shoulder of the housing.

13. The gas sensor according to claim 10, wherein:
the packing element includes a base end portion disposed between an outer periphery of the insulating element holder and an inner peripheral wall of the housing in an area dislocated from the stepped engaging shoulder of the insulating element holder.

14. The gas sensor according to claim 13, wherein:
the base end portion of the packing element has a protruding portion extending from an edge of the holder rest shoulder of the housing by a distance greater than 0.3 mm.

15. The gas sensor according to claim 10, wherein:
the packing element has a hardness in a range from Hv100 to 200.

16. The gas sensor according to claim 10, wherein:
the packing element is made of at least one material selected from the group including nickel, nickel alloy and stainless steel.

17. A gas sensor comprising:
a sensing element for detecting a concentration of specified gas in measuring gases;
an insulating element holder internally supporting the sensing element and having a large-diameter stepped engaging shoulder and a small-diameter stepped engaging shoulder;
a housing having a large-diameter inner peripheral wall and a small-diameter inner peripheral wall between which a large-diameter holder rest shoulder and a small-diameter holder rest shoulder are formed in face-to-face relation with the large-diameter stepped engaging shoulder and the small-diameter stepped engaging shoulder of the insulating element holder, respectively, for internally supporting the insulating element holder;
a packing element interposed between the stepped engaging shoulders of the insulating element holder and the holder rest shoulders of the housing;
an atmospheric side cover fixedly connected to one end of the housing so as to cover a base end portion of the sensing element in an atmospheric side atmosphere; and
a measuring gas side cover fixedly connected to the other end of the housing so as to cover a leading end portion of the sensing element in a measuring gas atmosphere;
wherein at least one of the holder rest shoulders of the housing is formed in the housing at an opening angle less than 120°, representing an angle defined with a pair of profile lines in a cross section on a plane including a center axis of the gas sensor, which allows the packing element to hermetically seal the atmospheric side atmosphere and the measuring gas atmosphere from each other.

18. A gas sensor comprising:
a sensing element for detecting a concentration of specified gas in measuring gases;
an insulating element holder internally supporting the sensing element and having a large-diameter stepped engaging shoulder and a small-diameter stepped engaging shoulder;
a housing having a large-diameter inner peripheral wall and a small-diameter inner peripheral wall between which an holder rest shoulder is formed in face-to-face relation with the large-diameter stepped engaging shoulder and the small-diameter stepped engaging shoulder of the insulating element holder, respectively, for internally supporting the insulating element holder;
a packing element interposed between the stepped engaging shoulders of the insulating element holder and the holder rest shoulders of the housing;
an atmospheric side cover fixedly connected to one end of the housing so as to cover a base end portion of the sensing element in an atmospheric side atmosphere; and
a measuring gas side cover fixedly connected to the other end of the housing so as to cover a leading end portion of the sensing element in a measuring gas atmosphere;
wherein the holder rest shoulder is formed in the housing at an opening angle less than 120°, representing an angle defined with a pair of profile lines in a cross section on a plane including a center axis of the gas sensor, which allows the packing element to hermetically seal the atmospheric side atmosphere and the measuring gas atmosphere from each other; and
wherein the packing element has a base end portion protruding to an area between the large diameter annular engaging shoulder of the insulating element holder and the large-diameter inner peripheral wall of the housing.
